(19) United States
(12) Patent Application Publication
(10) Pub. No.: US 2010/0088190 A1
(43) Pub. Date: Apr. 8, 2010

(54) METHOD AND SYSTEM FOR DETERMINING TRAVEL DESTINATIONS

(75) Inventors: Kevin FLIESS, Mountain View, CA (US); Eric WOOD, Menlo Park, CA (US); R. Jay GABANY, (US); Cyril BOUTEILLE, Mountain View, CA (US)

Correspondence Address: WILMERHALE/BOSTON, 60 STATE STREET, BOSTON, MA, 02109, US

(73) Assignee: TRAVELMUSE, INC., Los Altos, CA (US)

(21) Appl. No.: 12/246,549

(22) Filed: Oct. 7, 2008

(51) Int. Cl. G06Q 30/00; G06Q 50/00; G06F 17/30

(52) U.S. Cl. 705/26; 707/E17.005; 707/E17.016

(57) ABSTRACT

The invention can include a method or a system for determining one or more travel destinations. According to one aspect, the method includes presenting a query interface to a user, receiving a set of parameters from a user through the query interface, matching the received set of parameters with one or more travel destinations from a database of potential travel destinations, and presenting one or more travel destinations to the user. The parameters received from the user through the query interface can include, for example, a departure location, one or more desired activities for a vacation, and a maximum travel time or distance. The database includes attributes matching one or more activities to each travel destination. As such, the database can match a set of parameters received from a user with one or more travel destination. Another embodiment of the invention can include a disk, tape, or other electronic media that stores instructions to carry out the steps set forth above.

### FIELD OF THE INVENTION

The invention relates generally to methods and systems for determining travel destinations, and more particularly to matching a set of parameters from a user with travel destinations in order to recommend certain travel destinations.

### BACKGROUND OF THE INVENTION

There are many methods available to vacation travelers for making vacation travel reservations via the Internet or by phone, but these methods usually require the user to pre-select a destination. Typically, the traveler selects a desired location for travel and then researches that location to determine if the location is a desirable destination for the traveler. The traveler can, for example, review travel books or online websites for particular locations before making travel reservations to determine if the traveler is interested in those locations.

Many travelers also use travel agents for vacation planning. Travel agents typically present the traveler with one or more travel destinations and then describe the activities that are available at those destinations. If the traveler is interested in the activities available in a destination, the traveler may elect to vacation at that destination.

Although the methods described above can help a traveler find a destination for travel, the traveler may not be aware of other travel destinations that may be better suited for the traveler's interests, budget constraints, and time constraints.

### SUMMARY

One embodiment of the invention is a method for determining one or more travel destinations. According to this embodiment, the method includes presenting a query interface to a user, receiving a set of parameters from a user through the query interface, matching the received set of parameters with one or more travel destinations from a database of potential travel destinations, and presenting one or more travel destinations to the user. The parameters received from the user through the query interface can include, for example, a departure location, one or more desired activities for a vacation, and a maximum travel time or distance. The database includes attributes matching one or more activities to each travel destination. As such, the database can match a set of parameters received from a user with one or more travel destinations. The attributes, or tags, can represent activities that can be experienced at each destination. Another embodiment of the invention can include a disk, tape, or other electronic media that stores instructions to carry out the steps set forth above.

In the embodiments of the invention set forth above, the set of parameters received from the user can include a variety of parameters, including, for example, a travel budget, a travel date or season for travel, a trip duration, a travel luxury level indication for hotels and/or flights, and a number of travelers. If a user selects a maximum travel time, this can be expressed as an amount of time the user is willing to travel from the departure location. The user can also select, either in addition to the maximum travel time or alternatively, a maximum travel distance from the departure location.

The embodiments of the invention set forth above can be carried out on computer systems through, for example, the Internet. For example, the steps set forth above can be carried out on a server connected to the World Wide Web. The server can present a query interface to a user by presenting the interface to the user's computer over the Internet. The server can have an associated database with the potential travel destinations, and the server can match parameters received from the user with the potential travel destinations.

Yet another embodiment of the invention is a system for determining one or more travel destinations. According to this embodiment, the system includes a query interface for presentation to a user, where the query interface can be used to receive a set of parameters from the user, a database of potential travel destinations, an engine to match the received set of parameters with one or more travel destinations from the database, and a presentation engine to present the one or more travel destinations to the user. In this embodiment, the parameters received from the user through the query interface can include, for example, a departure location, one or more desired activities for a vacation, and a maximum travel time or distance. The database can include attributes matching one or more activities to each travel destination. As such, the database can match a set of parameters received from a user with one or more travel destinations.

### BRIEF DESCRIPTION OF THE DRAWINGS

FIG. 1 is a schematic diagram of an environment for use of the invention;

FIG. 2 is a flow chart illustrating one embodiment of the invention that can use the environment of FIG. 1;

FIG. 3 is one embodiment of a query interface for use in the embodiments of FIGS. 1 and 2; and

FIG. 4 is one embodiment of a presentation screen for use in the embodiments of FIGS. 1 and 2.

### DETAILED DESCRIPTION

One embodiment of the invention is an inspiration destination finder that offers an automated method for planning a vacation trip or determining a destination for travel. Travel agents are often confronted by clients who want to take a trip and have one or more activities that spark their interest, but have no idea about the best destination to visit that also falls within a time and monetary budget. Use of a travel agent's expertise typically requires the payment of a fee, and this can be avoided by some embodiments of the invention. In particular, these embodiments offer potential vacation travelers a convenient method of finding desired travel destinations via the Internet at no cost. The embodiments of the invention can solicit specific information from the user so that multiple destinations and package offerings can be suggested that meet the user's vacation expectations, budgetary constraints, and other interests. The embodiments of the invention set forth herein can be used by prospective travelers who do not know the best places to visit that will accomplish their vacation activity requirements within a specified monetary budget. The embodiments of the invention can also be used by professional travel agents to select vacation packages for clients.

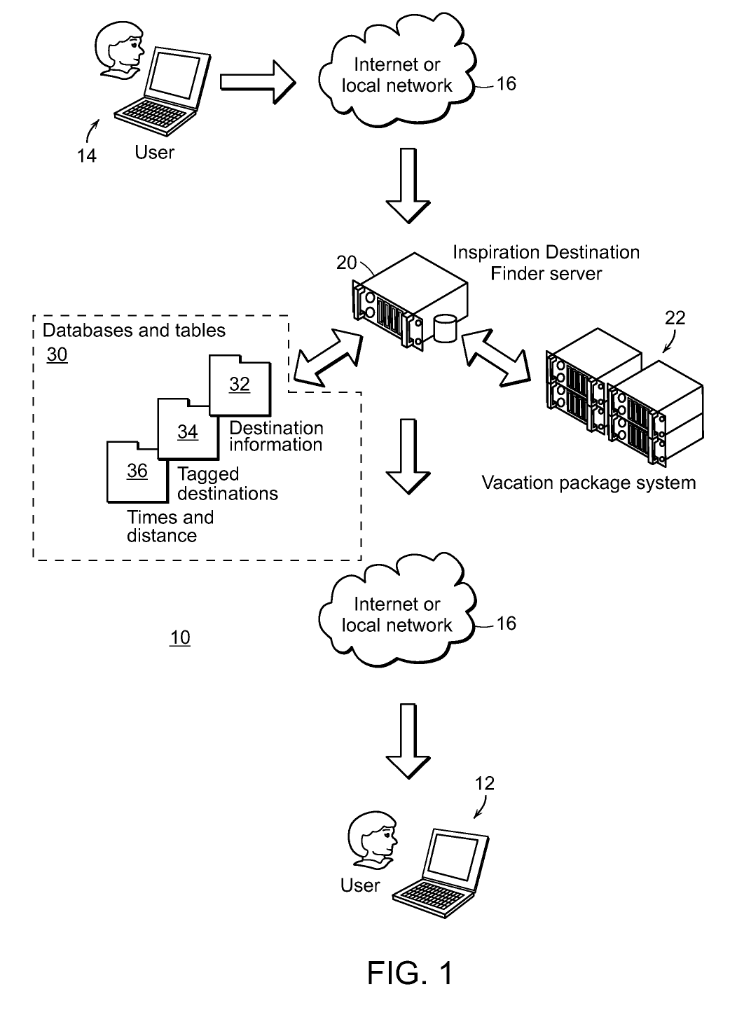

FIG. 1 is an environment 10 for use of one embodiment of the invention. In this embodiment, one or more users communicate through user computers 12, 14 via the Internet 16 or suitable local network with a server 20, a vacation package system 22, and a database 30 containing tagged travel destinations associated with the server 20. In FIG. 1, the server 20 is referred to as an inspiration destination finder server.

Briefly, in operation, the server 20 of the environment 10 of FIG. 1 can be used to present a travel destination to a user. The server 20 can present a query interface to a user, who can then select parameters such as a departure location, a variety of activities desired for travel, and a maximum travel time or distance. The activities can represent things vacation travelers can do when they visit a destination. The user can submit these parameters through the query interface to the server 20. The server 20 can then use an engine to search through the database 30, which contains tagged travel destinations, to find destinations that match the parameters selected by the user. One or more matched destinations can then be presented to the user computer 12 or 14. For example, if a destination is close enough in terms of time and/or distance and matches enough of the user's desired activities, it can be presented to the user as a possible vacation destination. In addition, the server 20 can match possible destinations with packages in the vacation package system 22, and these vacation packages can also be presented to the user.

Referring again to FIG. 1, the database 30 can include a variety of different tables, spreadsheets, or databases. FIG. 1, for instance, shows a database 30 that contains a database of destination information 32, a database of tagged destination information 34, and a table of travel times or distances 36. In other embodiments, a variety of different databases, tables, or spreadsheets can be associated with database 30. As shown in FIG. 1 and described above, the database 30 is associated with the server 20 such that the server 20 can search through the database 30 in a manner that will be described herein.

The database of destination information 32 includes a database of information about each destination that can be recommended by the server 20 to the user. The database of destination information 32 can include basic factual information about each destination. For example, this database 32 can include the latitude and longitude of each destination, which the server 20 can use to determine the travel time or distance from a selected departure city. The database 32 can also include descriptive content information about each destination. This information can be in the form of links to websites or books that describe the destination, or it can be basic information about the climate, languages spoken, monetary units, and other basic information about the destination. This database 32 can also include photographs depicting the destination and available activities, as well as professional editorial and user ratings for the location. As such, the database of destination information 32 can be used to generate information to be presented to the user for destinations matched with the user's selected parameters.

The database of tagged destination information 34 can include a lengthy database that contains information that is tagged with each particular destination. The terms “tag” and “attribute” are used synonymously herein. The tags or attributes can represent activities that can be experienced at each destination. As such, tags or attributes can be attributes that define a destination, such as activity attributes. For example, tags or attributes can include an indication as to whether the following activities are available at each destination: beach vacations, hiking, deep sea fishing, museum visits, romantic getaways, spas, bike riding, and shopping. Numerous other types of activities can be tagged with a destination within the scope of the invention. The database of tagged destination information 34 can include hundreds or even thousands of destinations, each of which can have tens of tags for activities associated with the destination. For example, one location, such as Maui, Hawaii, may have the following activities tagged with it: beach vacations, hiking, deep sea fishing, romantic getaways, spas, bike riding, scuba diving, snorkeling, surfing, swimming, kayaking, mountain biking, and luxury travel. Information that is tagged with a particular destination means that a particular attribute or tag is linked to the destination or listed in a searchable database associated with the particular destination.

In some embodiments, tags can be associated with a particular destination only if the activity at issue is one of the popular activities which enhance or are synonymous with the reputation, notoriety, or desirability of the destination. For example, most medium-sized and larger cities have one or more museums but only destinations like Paris, London, Rome, New York City, Amsterdam, and Washington DC (to name a few) have the number of world-class opportunities that warrant a museum tag. As such, in some embodiments, an activity can be tagged with a destination only if the activity is well-known for that destination.

As such, the database of tagged destination information 34 allows the server 20 to search for destinations that include a variety of activities for travel. This is because travelers seldom have a single activity goal when traveling for a vacation—they want to experience or accomplish many things. The query interface allows users to select multiple diverse activities (such as beaches, museum visits, spas, theme parks and bike riding, for example) and return a ranked set of destinations that offer all or most of these opportunities. The set of tags in the database of tagged destination information 34 allows for the compilation of firsthand knowledge or extensive research about each destination in the database 30.

The table of travel times or distances 36 in the database 30 can include, for example, a table of flight, cruise, train or automobile driving times from a large variety of departure locations to each of a large number of destinations. The table can include the time it takes to travel from a departure location to the destination location, the distance from the departure location to the destination location, both the travel time and distance to the destination location, or only one of the travel time or distance to the location. This table or set of tables 36 allows the server 20 to determine if a destination location is close enough for a user based on the user's travel constraints in terms of time or travel distance.

The vacation package system 22 of FIG. 1 can be used to present vacation packages to the user. For example, the vacation package system 22 can contain commercial vacation packages and prices for each of a number of destinations in the database 30. If a destination meets the user's travel desires, the vacation package system 22 can be used to present packaged vacations to the user. For example, the vacation package booking system 22 can present pre-packaged, discount priced hotel and airline combinations based on the submission of required travel parameters, such as departure and destination city, travel dates, budgetary constraints, and other parameters.

The server 20 shown in FIG. 1 contains one or more engines that perform a variety of functions. In general, the purpose of the engine(s) in the server 20 is to search through the database 30 in order to match destinations with desired parameters, including activities, selected by the user. At a high level, the server 20 can present a query interface to the Internet or local network for presentation to the user computer 12, 14 via a common web browser, access a data store of destination information (with, for example, the information described above in connection with database 30), match the parameters selected by the user through the query interface with destinations in the database 30, and then present to the user through the Internet or local network via a common web browser an interface that depicts the matched results or recommendations. The recommendations can include, for example, a ranked list of destinations with basic information about those destinations, and/or a list of vacation packages from the vacation package system 22.

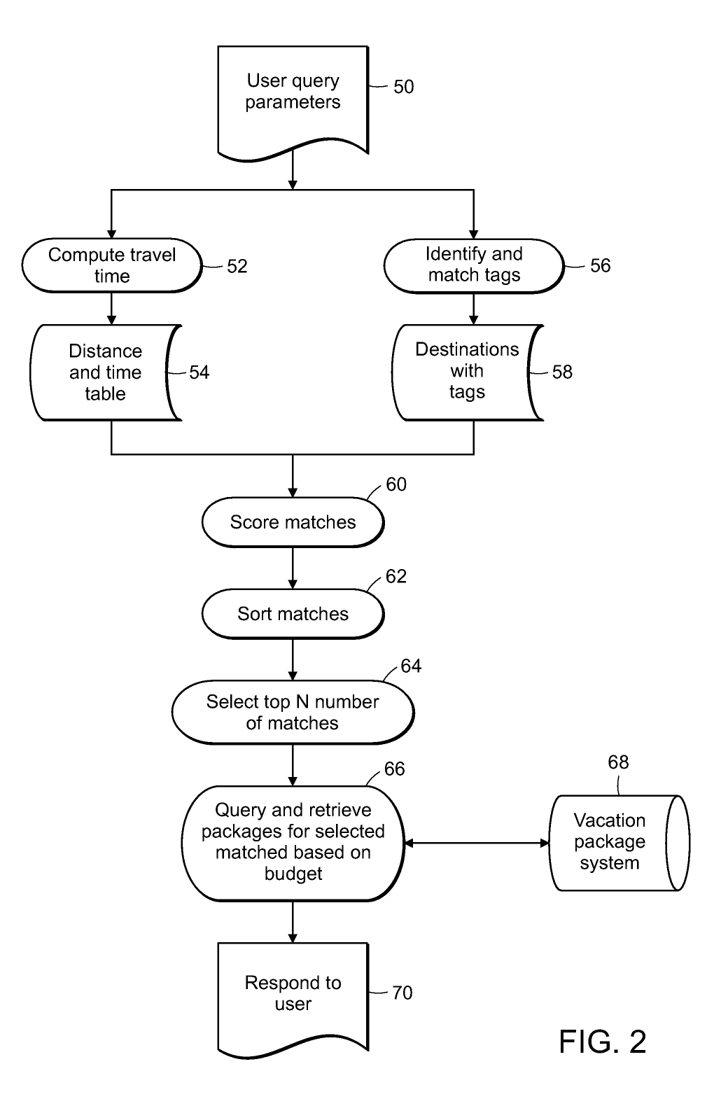

FIG. 2 is a flow chart illustrating one embodiment of the invention using the environment 10 of FIG. 1. More particularly, FIG. 2 depicts the logic performed by an engine of the server 20 of FIG. 1 to compute results of travel destinations in real-time. FIG. 2 begins with the presentation of a query interface and reception of query parameters from a user in block 50. In this embodiment, the query parameters include at least a departure location, a maximum travel time, and a set of desired activities for travel. In block 52, the engine of the server 20 computes the travel time between the departure location and each of the destinations in the database 30. In performing this task, the engine uses information in a time and distance table, as shown in block 54 of FIG. 2. As an example, step 52 can include computing the travel time by flight between a departure location airport and a destination location airport.

The engine of the server 20 also identifies and matches selected activities with tags for each of the destinations, as shown in block 56 of FIG. 2. For each destination in the database 30, the engine identifies the number of activity tags for this destination that match the user's selected activities or parameters. In performing this task, the engine uses information in a destinations with tags database, as shown in block 58 of FIG. 2.

At block 60, the engine computes a score for each destination based upon whether the destination is close enough in terms of travel time/distance and by the number of activities matched with the destination. In addition, the user's selected budget can also be used in scoring destinations. As an example, if a destination is not close enough to the user's departure location based on the user's desired travel time, that destination can be excluded or provided a low score so that it likely will not be presented to the user. Similarly, if a destination does not match any or only matches one activity selected by the user, that destination will receive a low score. In addition, a destination can receive a higher score (making it more likely for presentation to the user) if a larger number of selected activities match the tags for that destination. At block 62, the destinations can be sorted by score from, for example, highest score to lowest score.

At block 64 of FIG. 2, the engine can select the top N number of destinations based on the top N scores. For example, in one embodiment the top 10 scores (i.e., N=10) can be selected, while in other embodiments the top 100 scores (i.e., N=100) can be selected. The number N can vary in different embodiments of the invention based on the user's desired number of matched destinations or based on the programming of the server 20.

At block 66 of FIG. 2, the server 20 uses the vacation package system 68 to determine if there are available vacation packages that match with the top N destinations. If there are available vacation packages that meet the user's budgetary constraints and that match one of the top N destinations, these packages can be retrieved for presentation to the user. Block 70 of FIG. 2 depicts the server 20 responding to the user by presenting the top N destinations. In some embodiments, the top N destinations can be presented along with available vacation packages and associated prices retrieved in step 66. Finally, in some embodiments, the system and method of the invention can be used by the traveler to book a vacation to a selected destination.

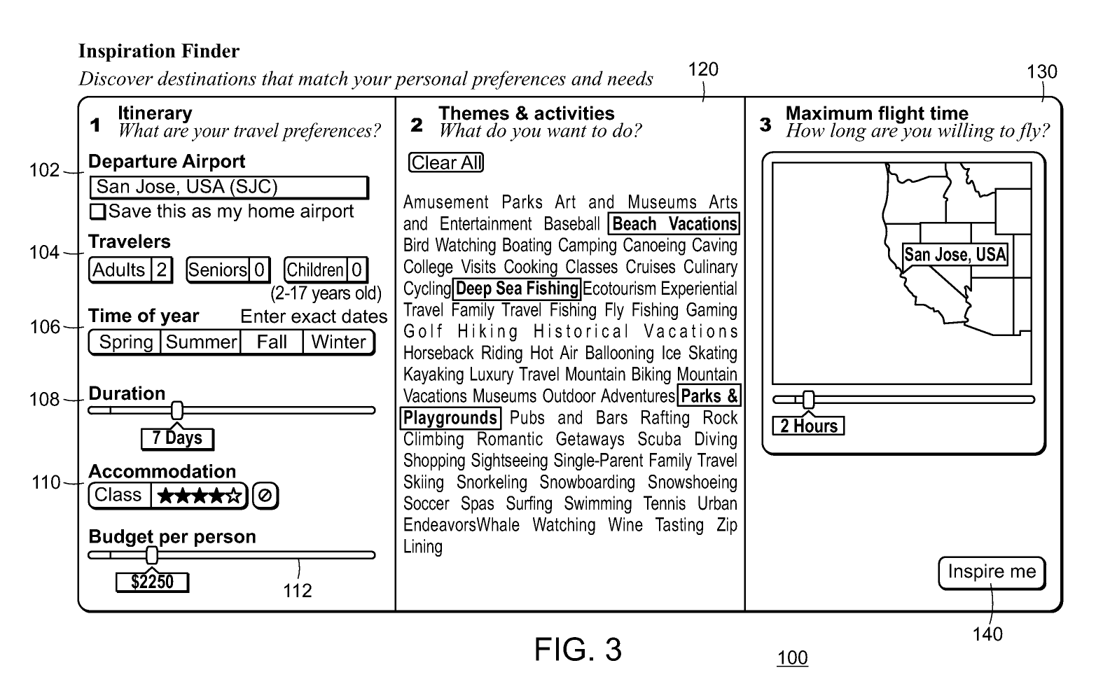

FIG. 3 shows one example of a query interface 100 that can be presented to a user according to one aspect of the invention. The server 20 of FIG. 1 can present the query interface 100 to a user through the Internet or local network, via a common web browser. The query interface 100 can include selection tools that allow the user to select a departure location 102, a number of travelers along with the ages of the travelers 104, the time of year 106 for travel, which can also be exact dates, the duration 108 of a desired trip in days or weeks, the accommodation class 110 for the trip, and an approximate or maximum budget per person 112. Common selection tools including drop-down boxes, sliding bars, and the like can be used within the scope of the invention, as can other selection tools. The accommodation class can include the desired class of a hotel, such as budget, standard, or luxury, as well as the desired class for air travel.

The query interface 100 of FIG. 3 also includes a selection tool 120 for the selection of activities. The activities can include any of the activities set forth above or in FIG. 3. In addition, other activities also fall within the scope of the invention. The activities can also be grouped under a number of different themes. For instance, FIG. 3 depicts certain themes in bold. If the user selects “Beach Vacations” as a theme, a number of possible beach-related activities can be presented to the user for selection. Alternatively, a theme can be a common activity that a large number of users are likely to select.

The query interface 100 of FIG. 3 also includes a selection tool 130 for a maximum flight time. This tool 130 can allow the user to select a maximum flight time in hours. In other embodiments, this tool 130 can allow the user to select a maximum distance in mile by flight, a maximum time or distance by car, or any other method of selecting a time or distance for travel. As shown in FIG. 3, the user can submit the parameters selected in the query interface 100 to the server 20 by clicking a submit button 140, labeled “Inspire me” in FIG. 3.

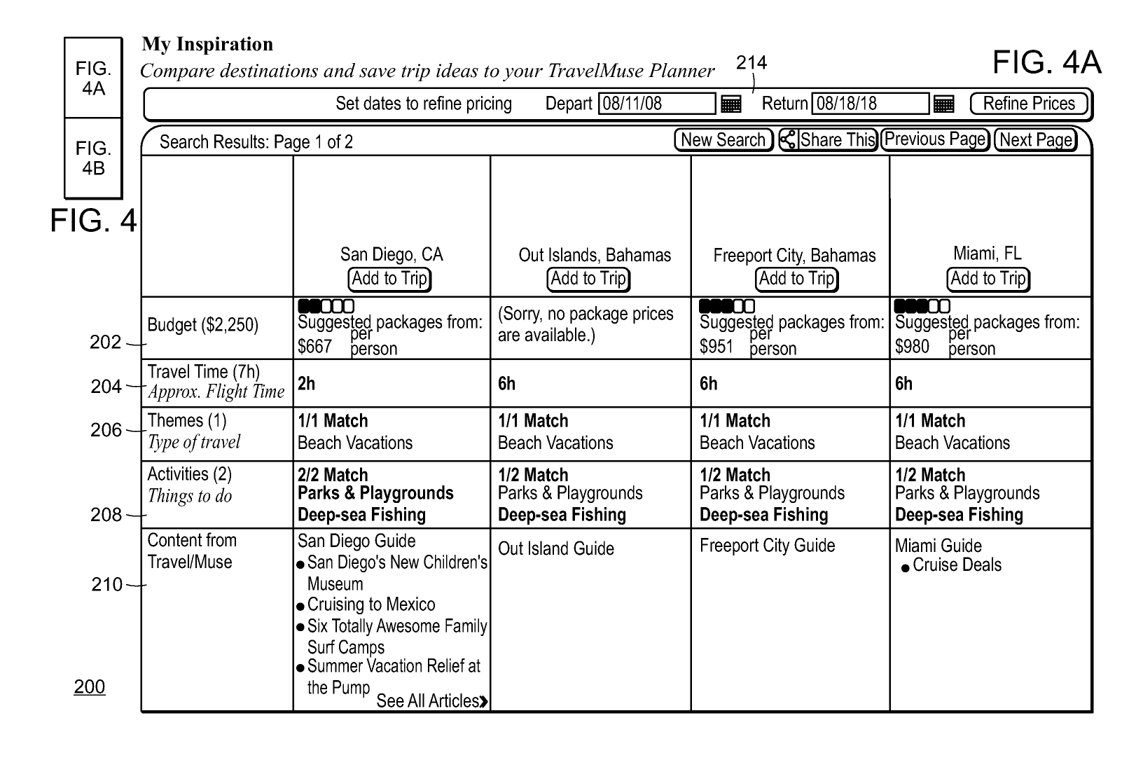

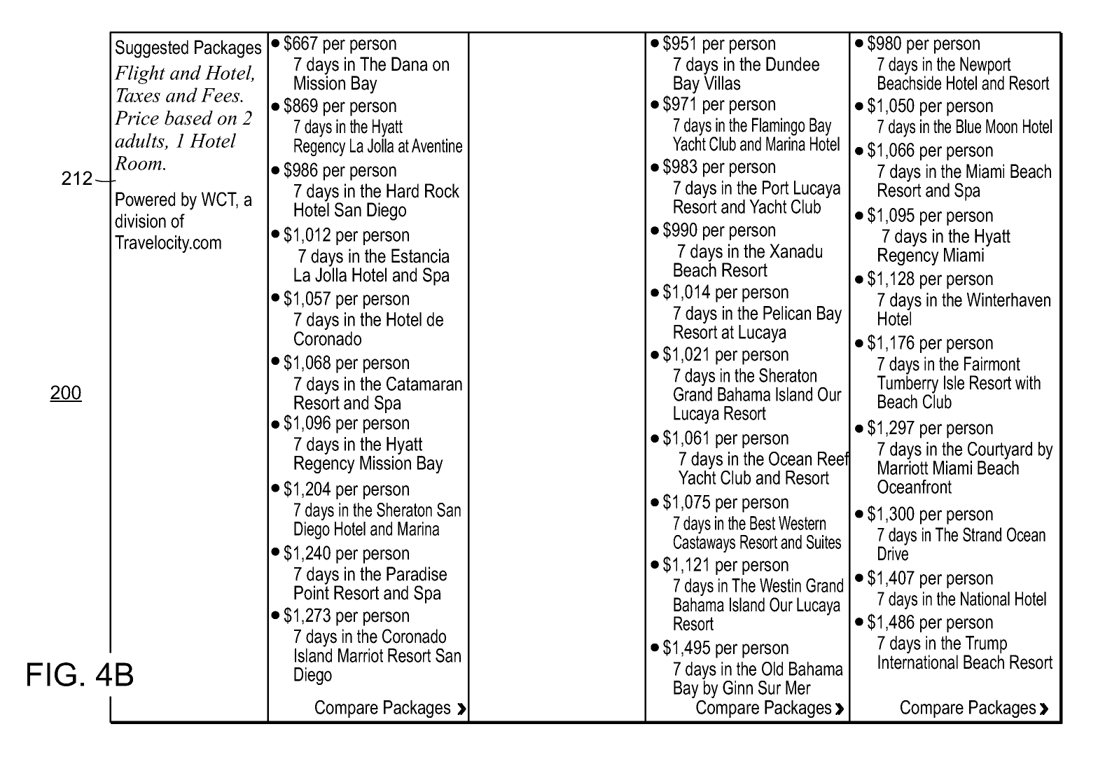

FIG. 4 shows one embodiment of a presentation screen 200 that can be presented to the user after the engine of the server 20 of FIG. 1 finds travel destinations and/or travel packages for a user. The presentation screen 200 of FIG. 4 includes a table with five columns, with each of the last four columns representing a different location for travel. In other embodiments, the number of presented destinations can be larger or smaller than shown in FIG. 4. FIG. 4 also shows a number of rows in the table, with each row representing different information about the destinations as set forth in the first column of the presentation screen 200. The first column contains header information on items such as the budget, travel time, themes, activities, and other information.

In the presentation screen 200 of FIG. 4, row 202 represents the budget for the destination. The first column of row 202 shows the budget selected by the user, and the entries under each column represent the budget necessary for travel to the depicted destination. For example, for travel to Freeport City in the Bahamas, the cheapest budget for travel that matches the user's constraint is $951. In this embodiment, the cheapest budget matches the cheapest vacation packaged matched by the vacation package system 22.

Row 204 represents the travel time to the destination. Once again, the entry in the first row represents the travel time selected by the user. Row 206 represents the themes that match for each destination. Row 208 represents the activities for each destination that match those selected by the user. Row 210 represents content for the destination, where the content can originate from the destination information database 32 of FIG. 1. Row 212 represents suggested vacation packages for each destination. The vacation packages can be generated through use of the server 20 and vacation package system 22 shown in FIG. 1.

The presentation screen 200 of FIG. 4 also includes a selection tool 214 for refining a search. In the embodiment of FIG. 4, the selection tool 214 allows the user to change departure and return dates. In other embodiments, the selection tool 214 can allow the user to change departure location, activities, and travel times or distances.

As described herein, the method and system of the invention provide the ability to integrate the traveler's vacation parameters (as exemplified by the query interface described above) with a list of activity tagged destinations, a table of travel times, a real-time vacation package booking system, and then respond back to the traveler with a set of destinations that include actionable travel booking options, such as vacation packages. The method and system presented herein offers vacation travelers a method for determining the best destinations that meet their vacation travel requirements.

The method and system according to the present invention can be implemented using a combination of automated interfaces and manual processes. It should be appreciated, however, that a greater use of automated processing and a wider range of product features with multiple executions and elections are also contemplated by the present invention. This description provides for an implementation in which a travel agent can enter information on behalf of a client or an individual traveler (that is, not a travel agent) can enter information for that traveler's own desired trip.

The embodiments of the invention described herein can be implemented, at least in part, using software-controlled programmable processing devices, such as a computer system. One or more computer programs for configuring such programmable devices or systems of devices to implement the foregoing described methods are to be considered an aspect of the present invention. The computer programs can be embodied as source code and undergo compilation for implementation on processing devices or a system of devices, or can be embodied as object code. Those of ordinary skill in the art will readily understand that the term computer or server in their most general sense encompass programmable devices such as those referred to above, and data processing apparatus, computer systems and the like.

In some embodiments, the computer programs are stored on carrier media in machine or device readable form, for example in solid-state memory or magnetic memory such as disk or tape, and processing devices utilize the programs or parts thereof to configure themselves for operation. The computer programs can be supplied from remote sources embodied in communications media, such as electronic signals, radio-frequency carrier waves, optical carrier waves and the like. Such carrier media are also contemplated as aspects of the present invention.

It will thus be seen that the objects set forth above, among those made apparent from the preceding description, are efficiently attained and, since certain changes can be made in carrying out the above method and system without departing from the spirit and scope of the invention, it is envisioned that all matter contained in the above description and shown in the accompanying drawings shall be interpreted as illustrative and not in a limiting sense. Accordingly, the invention should not be limited by the description above, but instead only by the following claims.

What is claimed is:

1. A method for determining one or more travel destinations comprising:
presenting a query interface to a user;
receiving a set of parameters from a user through the query interface, the parameters including a departure location, one or more desired activities, and a maximum travel parameter;
matching the received set of parameters with one or more travel destinations from a database of potential travel destinations, the database including attributes matching one or more activities to each travel destination; and
presenting the one or more travel destinations to the user.

2. The method of claim 1, wherein the set of parameters further comprises a budget, a travel date or season for travel, a trip duration, a travel luxury level indication, and a number of travelers.

3. The method of claim 1, wherein the maximum travel parameter is a distance the user is willing to travel from the departure location.

4. The method of claim 1, wherein the maximum travel parameter is a time amount the user is willing to travel from the departure location.

5. The method of claim 1, wherein the database includes a table of destination times and distances from a plurality of departure locations.

6. The method of claim 5, wherein the table includes travel times by flight, cruise, train, or automobile.

7. The method of claim 1, wherein the database includes a vacation package list.

8. The method of claim 7, wherein the step of matching includes matching one of the travel destinations with a vacation package from the vacation package list.

9. The method of claim 8, wherein the act of presenting includes presenting one or more vacation packages with the one or more travel destinations.

10. A system for determining one or more travel destinations comprising:
a query interface for presentation to a user, the query interface being used to receive a set of parameters from the user, the parameters including a departure location, one or more desired activities, and a maximum travel parameter;
a database of potential travel destinations, the database including attributes matching one or more activities to each travel destination;
an engine to match the received set of parameters with one or more travel destinations from the database of potential travel destinations; and
a presentation engine to present the one or more travel destinations to the user.

11. The system of claim 10, wherein the set of parameters further comprises a budget, a travel date or season for travel, a trip duration, a travel luxury level indication, and a number of travelers.

12. The system of claim 10, wherein the maximum travel parameter is a distance the user is willing to travel from the departure location.

13. The system of claim 10, wherein the maximum travel parameter is a time amount the user is willing to travel from the departure location.

14. The system of claim 10, wherein the database includes a table of destination times and distances from a plurality of departure locations.

15. The system of claim 14, wherein the table includes travel times by flight, cruise, train, or automobile.

16. The system of claim 10, wherein the database includes a vacation package list.

17. The system of claim 16, wherein the engine includes a package engine to match one of the travel destinations with a vacation package from the vacation package list.

18. The system of claim 17, wherein the presentation engine presents one or more vacation packages with the one or more travel destinations.

19. A computer-readable medium containing instructions that cause a system to perform a method to determine one or more travel destinations comprising:
presenting a query interface to a user;
receiving a set of parameters from a user through the query interface, the parameters including a departure location, one or more desired activities, and a maximum travel parameter;
matching the received set of parameters with one or more travel destinations from a database of potential travel destinations, the database including attributes matching one or more activities to each travel destination; and
presenting the one or more travel destinations to the user.

20. The computer-readable medium of claim 19, wherein the set of parameters further comprises a budget, a travel date or season for travel, a trip duration, a travel luxury level indication, and a number of travelers.
